(19) United States
(12) Patent Application Publication
(10) Pub. No.: US 2023/0138185 A1
(43) Pub. Date: May 4, 2023

(54) UNDERWATER COMPRESSED AIR STORAGE DEVICE OBTAINED BY A HYDRAULIC PUMP

(71) Applicant: ISAAC WOERLEN, VALENCIENNES (FR)

(72) Inventor: ISAAC WOERLEN, VALENCIENNES (FR)

(21) Appl. No.: 17/980,161

(22) Filed: Nov. 3, 2022

(30) Foreign Application Priority Data
Nov. 4, 2021 (FR) 2111710

(51) Int. Cl. F17C 1/00

(52) U.S. Cl. CPC F17C 1/007; F17C 2270/0128; F17C 2221/031; F17C 2227/046; F17C 2227/041

(57) ABSTRACT

An underwater compressed air storage device with at least one underwater compressed air tank, positioned on the floor (7) of a body of water and provided with at least one water outlet opening and at least one inlet opening (11, 13) for a mixture of water and air. A tank which has at least one compressed air storage volume provided with two connecting ducts (9, 11) between said volume and a collection chamber (5) for the water and air mixture, a first duct (9) located in the upper part of the volume ensuring the passage of compressed air in the volume and a second duct (11), at an altitude lower than the first duct (9), ensuring the passage of the water and air mixture in the volume, said tank also having at least one opening for discharging the degassed water into the body of water.

The present invention relates to an underwater compressed air storage device obtained by a hydraulic pump.

### DESCRIPTION OF RELATED ART

A hydraulic pump is an installation that compresses the air sucked into a water column by the Venturi effect. The height of the water column compresses the air. The separation of air and water takes place at the bottom of an inverted siphon, in order to obtain air at the hydrostatic pressure generated by the total head. In such installations, the waterfall is carried out by pipes of several meters, even tens of meters. It is thus possible to use compressed air as an energy source, for example to operate electricity generators or machines. Such installations placed on a body of water are known from US-B-6638024, which describes a device using a riverbed to receive a drop pipe for the mixture of water and air, the pipe opening out near a compressed air collection chamber located in the ocean. Here, storage is limited, with the compressed air being returned directly to land for use. As a result, only buffer storage is made in the available volume of the collection chamber.

The invention proposes a solution making it possible to easily store the compressed air produced by an underwater hydraulic pump, with a minimum of parts, at controlled costs.

### BRIEF SUMMARY OF THE INVENTION

To this end, the subject of the invention is an underwater compressed air storage device obtained by a hydraulic pump comprising at least one underwater compressed air tank, positioned on the floor of a body of water and provided with at least one water outlet opening and at least one inlet opening for a water and air mixture produced by the hydraulic pump, characterized in that the tank comprises at least one compressed air storage volume provided with two connection means between said volume and a collection chamber for collecting the water and air mixture into which a drop pipe opens for the water and air mixture located between the surface of the body of water and the floor of the body of water, a first passage means located in the upper part of the storage volume ensuring the passage of compressed air into the storage volume from the collection chamber and a second passage means, at an altitude lower than the first passage means, ensuring the passage of the water and air mixture into the storage volume from the collection chamber, said tank also having at least one opening for discharging the degassed water into the body of water.

Thus, owing to the invention, a compressed air storage means is available that is directly connected to the compressed air production device, the outlet of the device being directly connected to the tank, which, in addition to the collection chamber, ensures water and air separation.

According to advantageous but optional aspects of the invention, such a storage device may comprise one or more of the following features:

The entire bottom of the storage tank is open.

A tank comprises several storage volumes that are connected to each other and of variable capacity.

A tank comprises several storage volumes that are connected to each other and of identical capacity.

Several tanks connected in series are connected to at least one collection chamber.

Several tanks mounted in parallel are connected to at least one collection chamber.

### BRIEF DESCRIPTION OF THE VIEW OF THE DRAWINGS

The invention will be better understood and other advantages thereof will become clearer from the following description, which is provided by way of non-limiting example and makes reference to the enclosed drawing, in which:

FIG. 1 is a simplified schematic representation of a storage device according to one embodiment of the invention.

### DETAILED DESCRIPTION OF THE INVENTION

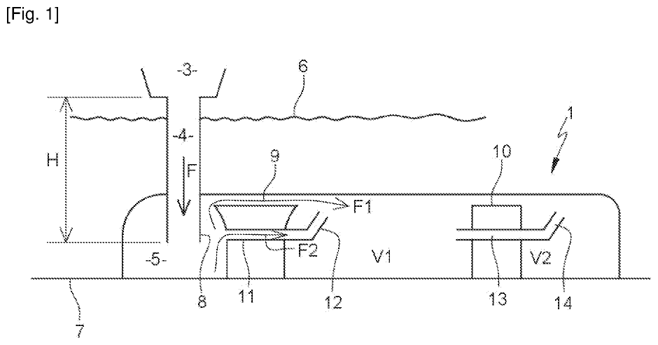

FIG. 1 is a schematic view of a storage device 1 or tank connected to a hydraulic pump. The hydraulic pump comprises a water and air supply tank 3 connected by a vertical drop pipe 4 to a collection chamber 5 for collecting the water and air mixture. The pipe 4, which hereinafter will also be called downpipe, extends between the surface 6 and the floor 7 of a body of water. The body of water can be a lake, a dam, a flooded quarry or the ocean. The length H of the pipe 4 depends on the depth of the body of water and directly determines the air pressure at the outlet of the collection chamber 5, it being understood that the relative pressure increases globally by one bar or 105 Pa every 10 meters.

The collection chamber 5 completely surrounds the end 8 of the drop pipe 4, the latter extending partially inside the chamber 5. According to an advantageous embodiment not illustrated, the end 8 of the drop pipe 4 is flared, funnel-shaped. In the upper part of the chamber 5, at an altitude higher than that where the end of the drop pipe 4 is located, at least one first connecting means formed here by a duct 9 connects the chamber 5 to a first volume V1 of the storage device 1. In the illustrated embodiment, the device 1 comprises a second volume V2, of smaller capacity. Alternatively, the volumes have the same capacity. The volumes V1 and V2 are connected at the top by at least one duct 10, which here is located in the same plane as the duct 9. With such a configuration, a continuity is defined between the chamber 5 and the volumes V1 and V2. It is conceivable that, as a variant, other volumes can be provided following the volume V2 and/or connected by other ducts to the chamber 5, from a point of connection other than that of the duct 9 to the chamber 5. In other words, several storage volumes, identical or not, can be arranged in series and/or several storage devices 1 in parallel, for example positioned all around the chamber 5. In addition, the different volumes can be configured in a ring.

The chamber 5 is also connected to at least one volume V1 by at least one second connecting means, also formed in the example by a duct 11. The duct 11 is positioned under the duct 9 and at an altitude at least equal to that of the end 8 of the pipe 4. Advantageously, as shown, the duct 11 is at an altitude slightly higher than that of the end 8. In another embodiment, the duct 11 can be positioned higher, but in any case under the duct 9. It should be noted that the end 12 of the duct 11 that opens into the volume V1 is bent and oriented upwards, in the direction of the surface 6 of the body of water. In the embodiment illustrated in FIG. 1, another duct 13 connects the volumes V1 and V2. Alternatively, the different volumes are interconnected by other means, known per se, than the ducts 11 and 13. Similarly, these ducts 11 and 13 are not bent, but straight. The geometric configuration of the ducts 12 and 13 are similar, knowing that their diameters may be different. As with the ducts 9 and 10, the number of ducts 12 and 13 may differ from that shown. In all cases, the various volumes V1, V2 of the storage device 1 are connected to each other and to the collection chamber 5 by two types of passage means, such as ducts: a first type of duct 9, 10 de facto forms a continuity of volume in the upper part of the chamber 5 with the volumes V1, V2, and a second type of duct 11, 13 connects these elements to each other, at an altitude higher than the altitude of the open end 8 of the pipe 4 relative to the floor 7. It should be noted that, in other embodiments, there are no ducts 11, 13, the passage of the water taking place directly through the open base of the volumes 5, V1, V2. This being the case, the presence of the ducts 11 and 13 is advantageous because they allow a longer residence time for the water in the various volumes, and therefore a longer degassing time.

Furthermore, the chamber 5 comprises a guide cone, not shown, for the flow of the water and air mixture leaving the end 8 of the pipe 4. This cone is positioned under the end 8, bearing on the floor 7 of the body of water. The height of the cone is adapted so that the upper part of the cone is in the vicinity of the duct 11 while remaining under the end 8, in order to guide the mixture leaving the pipe 4 upwards, which promotes degassing and the passage by the duct 11. The chamber 5 is advantageously provided with at least one drain, not shown, making it possible to discharge the water remaining in the chamber 5 and therefore to maintain pressure equilibrium. Such a drain consists of an orifice made in the wall of the chamber 5.

The operation of such a storage device 1 is now described with reference to the embodiment of FIG. 1. The water and air mixture arrives in the chamber 5 through the open end 8 of the pipe 4, according to the arrow F. At the outlet of the pipe 4, the flow rate of the water and air mixture decreases as one moves away from the end 8 to become almost zero. A funnel shape, not shown, of the end 8 promotes the slowing down of the mixture. The separation between water and air is then initiated. The water is discharged from the chamber 5 to mix with the water of the body of water through the openings, not shown, of the bottom of the chamber 5 in the lower part or, according to a preferred embodiment, through the fully open bottom of the chamber 5. The discharge takes place by balancing the hydrostatic pressures between the water in the chamber 5 and that in the body of water, the drain fitted to the chamber being activated if necessary. The air, which is compressed to the pressure prevailing in the chamber 5, therefore to the pressure corresponding to the depth at which the chamber 5 is placed, here on the floor 7 of the body of water, tends to reach the surface of the body of water. As a result, the compressed air is blocked in the upper part of the chamber 5. It will flow naturally throughout the available volume, remaining at the initial pressure, and will therefore pass through the duct 9 to join the volume V1, according to arrow F1. If, as illustrated, a second volume V2 is connected to the volume V1, the air will also occupy the upper part of the volume V2 passing through the duct 10. The air will thus occupy all the available volumes.

Part of the water and air mixture, not yet degassed, passes from the chamber 5 to the volume V via the duct 11, according to arrow F2. The orientation of the end 12 of the duct 11 facilitates, according to the illustrated embodiment, the degassing of the water and air mixture and therefore the recovery of the compressed air in the volume V1, in the upper part thereof. Alternatively, the end 12 of the duct 11 is not bent. As illustrated, part of the non-degassed water and air mixture passes directly from the volume V1 to the volume V2, degassing also taking place from the end 14 of the duct 13. In this way, the further one moves away from the chamber 5, the less water and air mixture passes into the storage volumes. The storage volumes furthest from the chamber 5 are those that contain the least mixture, therefore the least non-degassed water and the most compressed air.

Openings in the bottom or an open bottom of the volumes V1 and V2 allow, like for the chamber 5, the water to be discharged toward the body of water. Thus, by the flow of fluids, air and water, in the various constituent elements of the device 1, at the pressure prevailing in the body of water at the position of the various elements, progressive filling of the volumes V1, V2 with air is ensured, the air driving the water out of the volumes. The compressed air can be stored for a period of several days, weeks or months, while being prevented from being discharged toward the surface of the body of water. It is conceivable that it is advisable to secure, by known means, the constituent elements of the device 1 and of the chamber 5 to the floor 7 of the body of water and/or to the mainland in order to prevent any air from escaping due to movements of roll and/or pitch.

In another embodiment, at least one of the volumes V1, V2 is equipped with at least one discharge duct, not shown, for the compressed air toward the surface and/or the mainland. Such a pipe makes it possible to bring the compressed air to the desired pressure in a place of use and/or surface storage, for example a compressed air cylinder. In order to avoid any leakage at the surface, the duct used to discharge the compressed air toward the surface of the body of water can be closed by a means known per se, for example a valve. In all cases, this closure means is positioned on the surface, on the aerial part of the duct. In this way, maneuvering and maintenance of said closure means are facilitated, while avoiding the presence of moving parts underwater.

Such a device is advantageously modular, the various volumes being adapted and easily connectable to each other according to storage needs. Furthermore, the device 1 can equip a hydraulic pump already in place in a body of water, the connection of ducts 9 and 11 either taking place during underwater work or the chamber 5 is previously provided with means of connection to the ducts 9 and 11. Similarly, if the device is fitted as standard with a hydraulic pump, it is possible to add volumes in series or in parallel. As a variant, several pumps can be connected to a storage device 1 of suitable dimensions. In all cases, the construction of the device 1 is simple and easy to maintain. The absence of bottom in the various volumes allows a rapid and optimal balancing of the pressures between the interior and the exterior of the volumes, which means that it is not necessary to use constraining materials and construction solutions, all the elements being balanced in terms of internal and external hydrostatic pressure.

1. An underwater compressed air storage device (1) obtained by a hydraulic pump comprising at least one underwater compressed air tank, positioned on the floor (7) of a body of water and provided with at least one water discharge opening and at least one passage (11, 13) for a water and air mixture produced by the hydraulic pump, wherein the tank comprises at least one compressed air storage volume (V1) provided with two passages (9, 11) between said volume (V1) and a collection chamber (5) for collecting the water and air mixture into which a drop pipe (4) opens for the water and air mixture located between the surface (6) of the body of water and the floor (7) of the body of water, a first passage (9) located in the upper part of the storage volume (V1) ensuring the passage of compressed air into the storage volume (V1) from the collection chamber (5) and a second passage (11), at an altitude lower than the first passage (9), ensuring the passage of the water and air mixture into the storage volume (V1) from the collection chamber (5), said tank (V1, V2) also having at least one opening for discharging the degassed water into the body of water.

2. The device according to claim 1, wherein the entire bottom of the storage tank (V1, V2) is open.

3. The device according to claim 1, wherein a tank comprises several storage volumes (V1, V2) that are connected (10, 13) to each other and of variable capacity.

4. The device according to claim 1, wherein a tank comprises several storage volumes that are connected to each other and of identical capacity.

5. The device according to claim 1, wherein several tanks connected in series are connected to at least one collection chamber (5).

6. The device according to claim 1, wherein several tanks mounted in parallel are connected to at least one collection chamber.
